(19) United States
(12) Patent Application Publication
(10) Pub. No.: US 2020/0235602 A1
(43) Pub. Date: Jul. 23, 2020

(54) CONTROL APPARATUS, AND COMPUTER-READABLE STORAGE MEDIUM

(71) Applicant: HONDA MOTOR CO.,LTD., Tokyo (JP)

(72) Inventors: Motoki HISHIDA, Saitama (JP); Hakaru SADANO, Saitama (JP); Hiroyuki KANAZAWA, Saitama (JP)

(21) Appl. No.: 16/726,957

(22) Filed: Dec. 26, 2019

(30) Foreign Application Priority Data
Jan. 17, 2019 (JP) 2019-005707

(51) Int. Cl. H02J 7/00; G01C 21/36; H04W 4/021

(52) U.S. Cl. CPC H02J 7/00716; H02J 7/00036; H04W 4/021; H02J 7/0029; G01C 21/3697; H02J 7/0069

(57) ABSTRACT

A control apparatus includes: a determining unit that determines whether or not a vehicle provided with a driving power source is at a position where the vehicle can perform power transfer with a power network; and a notification control unit that makes a user of the vehicle notified, if the driven vehicle is at the position where the vehicle can perform power transfer with the power network. If the vehicle is positioned near a power transfer facility for performing power transfer between the vehicle and the power network, the determining unit determines that the vehicle is at the position where the vehicle can perform power transfer with the power network.

The contents of the following Japanese patent application are incorporated herein by reference: 2019-005707 filed on Jan. 17, 2019.

### BACKGROUND

### 1. Technical Field

The present invention relates to a control apparatus, and a computer-readable storage medium.

### 2. Related Art

There are known power management apparatuses that: receive an instruction for selecting one mode of a first mode of preferentially supplying power generated by a power generating device to the outside of a moving body and a second mode of preferentially charging power generated by the power generating device in a power storage device; and changes the destination of supply of power generated by the power generating device according to the instruction (see Patent Literature 1 explained below, etc., for example).

### PRIOR ART LITERATURES

### Patent Literatures

[Patent Literature 1] Japanese Patent Application Publication No. 2015-216836

[Patent Literature 2] Japanese Patent No. 5395764

### SUMMARY

For a system that performs power transfer between power networks and vehicles, it has been desired to effectively inform a user of a vehicle that the vehicle is at a location where the vehicle can perform power transfer with a power network.

### BRIEF DESCRIPTION OF THE DRAWINGS

FIG. 1 schematically illustrates the basic configuration of a power transfer system 100.

FIG. 2 schematically illustrates the functional configuration of a managing server 40.

FIG. 3 illustrates one example of a screen 300 for setting a scheduled period over which a vehicle 30 is kept connected to a charge/discharge facility 20.

FIG. 4 illustrates, in a table format, one example of schedule information.

FIG. 5 illustrates, in a table format, one example of connection history information indicating a history of connection of the vehicle 30 to a power network 10.

FIG. 6 illustrates, in a table format, one example of user information stored in a user information storage unit 284.

FIG. 7 illustrates one example of a screen 700 for notifying a user 80 that the vehicle 30 can be connected to the power network 10.

FIG. 8 is a flowchart illustrating processes related to user notification at the time of destination setting.

FIG. 9 is a flowchart illustrating processes related to user notification at the time of vehicle stop.

FIG. 10 shows an example of a computer 2000 in which embodiments of the present invention may be wholly or partly embodied.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention. Note that the identical or similar portions in drawings are given the same reference numbers, and repetitive explanations are omitted in some cases.

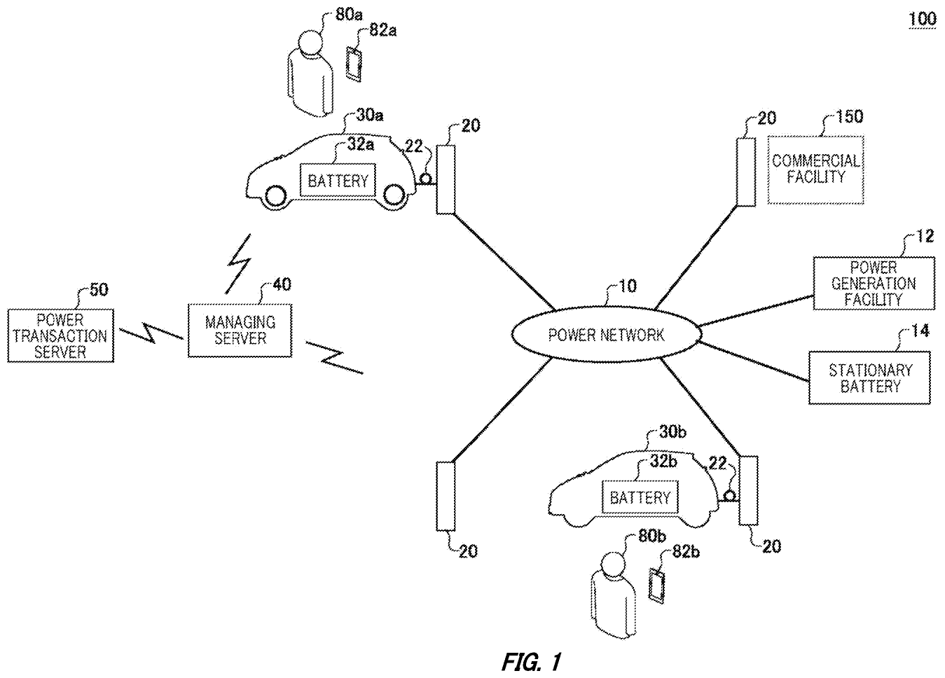

FIG. 1 schematically illustrates the basic configuration of a power transfer system 100. The power transfer system 100 is a system for a power aggregator, for example, to perform V2G (Vehicle-to-Grid) for exchange of power between vehicles and a power network by using batteries provided to the vehicles. The power transfer system 100 has a function of effectively informing a user that the user is at a location where power transfer can be performed between a vehicle and a power network. Note that, in V2G, at least either release of power by a vehicle to the power network or reception of power by a vehicle from the power network is performed.

The power transfer system 100 includes: a plurality of vehicles including a vehicle 30a, and a vehicle 30b; a stationary battery 14; a plurality of charge/discharge facilities 20; a managing server 40; a power generation facility 12; and a plurality of user terminals including a user terminal 82a, and a user terminal 82b.

A user 80a, and a user 80b are users of the power transfer system 100. In particular, the user 80a is a user of the vehicle 30a, and the user 80b is a user of the vehicle 30b. Note that a user of a vehicle may be any person who uses the vehicle such as an owner of the vehicle or a family member of the owner. In the present embodiment, the user 80a, and user 80b are generally called a “user 80” in some cases.

The user terminal 82a is a communication terminal used by the user 80a. The user terminal 82b is a communication terminal used by the user 80b. The plurality of user terminals including the user terminal 82a, and user terminal 82b are generally called a “user terminal 82” in some cases.

The user terminal 82 may be a mobile terminal, a personal computer, a vehicle navigation device, or the like, for example. Examples of the mobile terminal include a mobile phone, a smartphone, a PDA, a tablet, a notebook computer, a laptop computer, a wearable computer, and the like.

The vehicle 30a includes a battery 32a. The vehicle 30b includes a battery 32b. In the present embodiment, the plurality of vehicles including the vehicle 30a, and vehicle 30b are generally called a “vehicle 30” in some cases. In addition, a plurality of batteries including the battery 32a, and battery 32b are generally called a “battery 32” in some cases. The battery 32 may be any of various secondary batteries such as lithium ion batteries or nickel hydrogen batteries.

Note that the battery 32 is one example of a driving power source of the vehicle 30. The driving power source includes a power source that, like a fuel cell or the like, consumes a fuel to generate electric energy to be provided to a motive power source of the vehicle 30. The fuel may be hydrogen, a hydrocarbon fuel such as gasoline, light oil or natural gas, an alcohol fuel, or the like. The driving power source may be any power source that can generate electric energy to be provided to a motive power source of the vehicle 30.

The vehicle 30 is one example of a transportation device. The vehicle 30 is a vehicle including a motive power source to be driven by electric energy, such as an electric vehicle or a fuel cell vehicle (FCV), for example. Electric vehicles include a battery electric vehicle (BEV), a hybrid vehicle or plug-in hybrid electric vehicle (PHEV) including an internal combustion engine to provide at least part of motive power. In the present embodiment, the vehicle 30 is an electric vehicle including the battery 32 as a driving power source. In the form employing a battery as a driving power source, battery discharge corresponds to energy release from the driving power source, and battery charge corresponds to energy accumulation in the driving power source.

The managing server 40 is capable of communication with the vehicle 30, stationary battery 14, and user terminal 82 through a communication network. The managing server 40 is also capable of communication with a power transaction server 50 through a communication network. The communication networks may include wired communication or wireless communication transmission paths. The communication networks may include communication networks including the Internet, a P2P network, a dedicated line, a VPN, a power line communication line, a mobile phone line, and the like.

A power network 10 may include a power transmission system or a power distribution system of a power system, or a power distribution network of a power grid. The vehicle 30, stationary battery 14, charge/discharge facility 20, and power generation facility 12 are connected to the power network 10. The power network 10 may be provided for each region. The power network 10 may be a micro grid. The power network 10 may be a power distribution network of any scale that connects power devices that consume power, and power sources. For example, the power network 10 may be a power distribution network provided to any of facilities such as a commercial facility 150. The power network 10 may be provided for each building. The charge/discharge facility 20, stationary battery 14, and power generation facility 12 are capable of power transfer with the power network 10. The charge/discharge facility 20 is one example of power transfer facilities for performing power transfer between the vehicle 30 and the power network 10.

The power generation facility 12 is managed by an electric power company or the like. Charge/discharge facilities 20 include, for example, a charger/discharger installed at a residence, a charge/discharge station installed at a parking lot or public space of a multi-dwelling unit, a building or the commercial facility 150, and the like.

The vehicle 30 is connected to the charge/discharge facility 20 through a charge/discharge cable 22. That is, the vehicle 30 is connected to the power network 10 through the charge/discharge cable 22, and charge/discharge facility 20. The vehicle 30 performs power transfer between the battery 32 and the power network 10 through the charge/discharge facility 20. For example, the vehicle 30 releases power obtained by discharge of the battery 32 to the power network 10 via the charge/discharge cable 22, and charge/discharge facility 20. In addition, the vehicle 30 charges the battery 32 with power supplied from the power network 10 via the charge/discharge cable 22, and charge/discharge facility 20. Note that transfer of power between an entity and a power network 10 is called “power transfer with the power network 10” and the like in some cases.

The stationary battery 14 is managed by the power aggregator. The battery 32 of the vehicle 30 forms a virtual power plant along with the stationary battery 14. The managing server 40 is managed by the power aggregator. The managing server 40 controls power transfer between the battery 32 and the power network 10, and between the stationary battery 14 and the power network 10.

The managing server 40 performs power transaction by bidding in a wholesale power market. The power transaction server 50 is managed by an operator of the wholesale power market. The length of each time segment is defined as 30 minutes, and the managing server 40 places a bid in the power transaction server 50 in every time segment. The managing server 40 causes the battery 32, and stationary battery 14 to discharge power in each time segment based on a contract result to supply the power to the power network 10.

For example, the managing server 40 causes the battery 32, and stationary battery 14 to discharge power according to a contract amount which is a result of bidding in the wholesale power market by the power aggregator to supply the power network 10 with the power released from the battery 32, and stationary battery 14. In addition, the managing server 40 controls charge/discharge of the battery 32, and stationary battery 14 to balance power supply and demand in the power network 10 to an extent of the balancing power agreed in a transaction which is a result of bidding in the supply/demand balancing market by the power aggregator. For example, the managing server 40 controls charge/discharge of the battery 32, and stationary battery 14 according to an increased-demand response (increased-DR), a decreased-demand response (decreased-DR), and a increased/decreased-demand response (increased/decreased-DR) requested by a power transmission/distribution company or a retail electricity supplier.

Specifically, the managing server 40 controls at least one of the vehicle 30 and the charge/discharge facility 20 according to a increased-DR to thereby charge the battery 32 of the vehicle 30 with power received from the power network 10 through the charge/discharge facility 20. In addition, the managing server 40 controls at least one of the vehicle 30 and the charge/discharge facility 20 according to a decreased-DR to thereby cause the battery 32 of the vehicle 30 to discharge power, and cause the power obtained by the discharge of the battery 32 to be released toward the power network 10 through the charge/discharge facility 20.

In the present embodiment, the managing server 40 notifies the user 80 that the vehicle 30 can be connected to the power network 10 if there is a charge/discharge facility 20 at a location where the vehicle 30 is parked. For example, if a short distance wireless signal dispatched from the charge/discharge facility 20 is detected at the vehicle 30, the managing server 40 cause the user terminal 82 to issue a notification when the door of the driver's seat of the vehicle 30 is opened. Thereby, it is possible to effectively notify the user 80 that the vehicle 30 can be connected to the power network 10. Thereby, it is possible to help the user 80 not forget to connect the vehicle 30 to the charge/discharge facility 20 with the charge/discharge cable 22. Thereby, the power aggregator can more easily keep a capacity that is available for power transfer between the vehicle 30 and the power network 10. This eventually contributes to stabilization of power supply/demand in the power network 10.

Note that, in the present embodiment, power transfer means that power exchange from at least one of the vehicle 30 and the power network 10 to the other occurs. For example, power transfer may mean that power release is performed from the vehicle 30 toward the power network 10. In addition, power transfer may mean that power transmission is performed from the power network 10 toward the vehicle 30. Note that if the vehicle 30 releases power through a charger/discharger installed at a power consumer such as a home, net power supply to the power network 10 does not occur at a connection point between the power consumer's side and the power network 10 when the power consumption on the power consumer's side is greater than the power released from the vehicle 30, and the amount of power supply from the connection point to the power consumer simply decreases in some cases. In this case also, it can be considered that power exchange has occurred with the outside of the power network 10 from the perspective of the power network 10. Accordingly, it does not matter in the present embodiment whether or not the power network 10 receives net power from a particular connection point between the power network 10 and the vehicle 30 in power transfer with the power network 10 in which the vehicle 30 releases power.

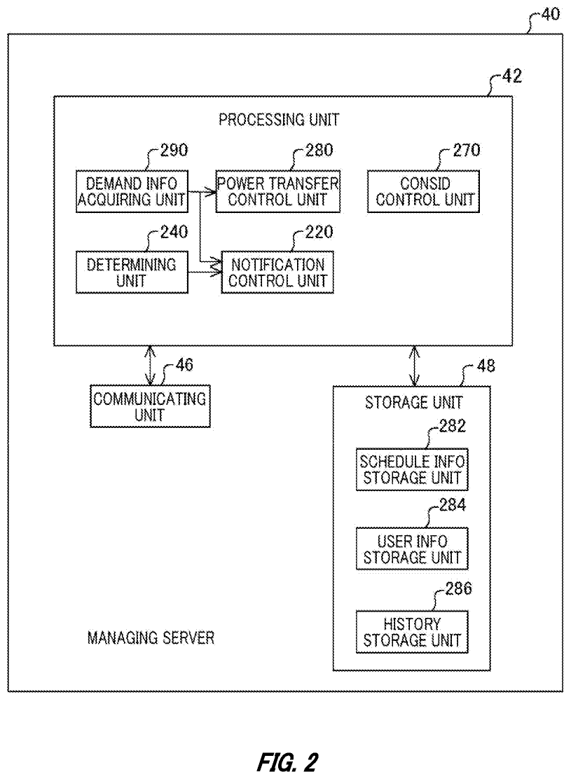

FIG. 2 schematically illustrates the functional configuration of the managing server 40. The managing server 40 includes a processing unit 42, a storage unit 48, and a communicating unit 46.

The processing unit 42 is realized by a processing device including a processor. The storage unit 48 is realized by a nonvolatile storage device. The processing unit 42 performs various types of process by using information stored in the storage unit 48.

The communicating unit 46 is responsible for communication with the vehicle 30, stationary battery 14, user terminal 82, and power transaction server 50. Information received by the communicating unit 46 from the vehicle 30, stationary battery 14, user terminal 82, and power transaction server 50 is supplied to the processing unit 42. In addition, information to be sent to the vehicle 30, stationary battery 14, user terminal 82, and power transaction server 50 is generated by the processing unit 42, and sent via the communicating unit 46.

The managing server 40 functions as a control apparatus. The managing server 40 may be a system realized by one information processing device, or may be a system realized by a plurality of information processing devices.

The processing unit 42 includes a notification control unit 220, a determining unit 240, a consideration control unit 270, a power transfer control unit 280, and a demand information acquiring unit 290. The storage unit 48 includes a schedule information storage unit 282, a user information storage unit 284, and a history storage unit 286.

The determining unit 240 determines whether or not the vehicle 30 is at a position where the vehicle 30 can perform power transfer with the power network 10. For example, if the vehicle 30 is positioned near the charge/discharge facility 20, the determining unit 240 determines that the vehicle 30 is at position where the vehicle 30 can perform power transfer with the power network 10. Specifically, if the vehicle 30 received a predetermined signal as a short distance wireless signal from the charge/discharge facility 20, the determining unit 240 determines that the vehicle 30 is at a position where the vehicle 30 can perform power transfer with the power network 10.

If the vehicle 30 is at a position where the vehicle 30 can perform power transfer with the power network 10, the notification control unit 220 makes the user 80 of the vehicle 30 notified. For example, if the vehicle 30 is at a position where the vehicle 30 can perform power transfer with the power network 10, the notification control unit 220 may make the user 80 of the vehicle 30 notified, when the vehicle 30 is stopped. If the vehicle 30 is at a position where the vehicle 30 can perform power transfer with the power network 10, the notification control unit 220 may make the user 80 of the vehicle 30 notified, when a door of the vehicle 30 is opened.

The notification control unit 220 may determine whether to or not to make the user 80 of the vehicle 30 notified, based on power demand in the power network 10 with which the vehicle 30 can perform power transfer. For example, the notification control unit 220 may determine whether to or not to make the user 80 of the vehicle 30 notified, based on power demand acquired by the demand information acquiring unit 290.

The notification control unit 220 determines whether or not there is a possibility that power transfer will be performed between the power network 10 and the vehicle 30, based on power demand in the power network 10 with which the vehicle 30 can perform power transfer. If there is an imbalance in power supply and demand in the power network 10, the notification control unit 220 may determine that there is a possibility that power transfer will be performed between the power network 10 and the vehicle 30. The notification control unit 220 makes the user 80 of the vehicle 30 notified, if there is a possibility that power transfer will be performed between the power network 10 and the vehicle 30.

The notification control unit 220 determines whether or not the battery 32 can perform power transfer with the power network 10, based on power capacity that is available for the battery 32 for power transfer with the power network 10. For example, the notification control unit 220 can determine whether or not the battery 32 can perform power transfer with the power network 10, based on the remaining capacity of the battery 32. If the battery 32 can perform power transfer with the power network 10, the notification control unit 220 makes the user 80 of the vehicle 30 notified.

If a destination of the vehicle 30 is set, the determining unit 240 further determines whether or not power transfer can be performed at the destination between the vehicle 30 and a power network 10 that supplies power in a region including the destination. If it is possible to perform power transfer at the destination between the vehicle 30 and the power network 10 that supplies power in the region including the destination, the notification control unit 220 further makes the user 80 of the vehicle 30 notified.

If it is determined that there is a possibility that power transfer will be performed between the power network 10 and the vehicle 30 based on power demand in the power network 10 that supplies power in the region including the destination in a time segment in which the vehicle 30 arrives at the destination, the notification control unit 220 makes the user of the vehicle 30 notified. The notification control unit 220 predicts a power capacity that is available in the battery 32 for power transfer with the power network 10 when the vehicle 30 arrived at the destination. For example, the notification control unit 220 predicts the remaining capacity of the battery 32 when the vehicle 30 arrived at the destination. If it is possible to perform power transfer between the battery 32 and the power network 10 based on the predicted power capacity, the notification control unit 220 may make the user of the vehicle 30 notified.

The schedule information storage unit 282 stores information about a scheduled period of connection of the vehicle 30 to the charge/discharge facility 20. For example, the schedule information storage unit 282 stores information specifying a scheduled period sent from the user terminal 82 to the managing server 40. If the vehicle 30 is positioned near the charge/discharge facility 20, and the scheduled period stored in the schedule information storage unit 282 includes the current time, the notification control unit 220 may make the user 80 notified. If the difference between the start time of the scheduled period stored in the schedule information storage unit 282 and the current time is shorter than a predetermined value, the notification control unit 220 may make the user 80 notified.

The demand information acquiring unit 290 acquires information indicating power demand in the power network 10. The information indicating power demand may include: information indicating a power demand amount in the power network 10; information indicating an amount of power supply from the power generation facility 12; information indicating supply/demand balance of power in the power network 10; and the like. The information indicating the power demand may include information indicating the balancing power in the power network 10.

Note that the contract amount in power transaction mentioned above is one example of the information indicating the power demand. The information indicating the power demand may be a contract price in power transaction or a contract type indicating whether a transaction is a buy contract or a sell contract. In addition, the information indicating the power demand may be information indicating an amount of real-time imbalance between supply and demand in the power network 10 or may be information indicating a predicted value of an amount of future imbalance between supply and demand. The information indicating the power demand may be information indicating a real-time power consumption amount of the power consumer in the power network 10 or a predicted value of the power consumption. Information that can be applied to the information indicating the power demand is not limited to power amounts themselves, but include various types of information that directly or indirectly affects power demand such as temperature information, humidity information, weather information, or event information.

Note that examples of the power transaction market include transaction markets such as a day-ahead market, an intraday market, and a supply/demand balancing power market. Forms that can be applied as the transaction form of power transaction include various transaction forms other than the transaction forms in these power transaction markets.

The power transfer control unit 280 causes the vehicle 30 to perform power transfer with the power network 10 according to the power demand in the power network 10. The power transfer control unit 280 communicates with the ECU of the vehicle 30 to successively acquire power transferability information indicating whether or not the vehicle 30 is connected to a charge/discharge facility 20 available for power transfer with the power network 10. If the vehicle 30 is available for power transfer with the power network 10, the power transfer control unit 280 instructs the ECU provided to the vehicle 30 to perform charge/discharge of the battery 32 according to power demand indicated by information acquired by the demand information acquiring unit 290. The ECU of the vehicle 30 communicates with the charge/discharge facility 20 according to the instruction of the power transfer control unit 280, and controls a power converter of the vehicle 30 to perform charge of the battery 32 through the charge/discharge facility 20 or release of power obtained through discharge of the battery 32. Note that the power transfer control unit 280 may successively acquire, from the ECU of the vehicle 30, information indicating: an amount of power input from the charge/discharge facility 20 to the power converter at the time of charge of the battery 32; an amount of power output from the power converter to the charge/discharge facility 20 at the time of discharge of the battery 32; and the SOC (State of Charge) of the battery 32. The power transfer control unit 280 may control power transfer between the vehicle 30 and the power network 10 based on the information acquired from the ECU of the vehicle 30.

If the vehicle 30 and the charge/discharge facility 20 were connected, the consideration control unit 270 generates information about a consideration given to the user 80 of the vehicle 30. The consideration information indicates the consideration for the fact that the vehicle 30 and the charge/discharge facility 20 were connected. The consideration information may be points, or the like, for example. The consideration information is stored in the user information storage unit 284.

With the managing server 40, it is possible to notify the user 80 in a timely manner if the vehicle 30 can be connected to the power network 10. Thereby, it is possible to prevent the user 80 from forgetting to connect the vehicle 30 to the charge/discharge facility 20.

Note that at least some of functions of the managing server 40 explained in the present embodiment may be realized by a combination of the managing server 40 and the ECU of the vehicle 30. For example, at least some of the functions for processes executed by the managing server 40 in the present embodiment may be executed by the ECU of the vehicle 30. For example, at least some of processes to be executed by the determining unit 240, and notification control unit 220 may be executed by the ECU of the vehicle 30.

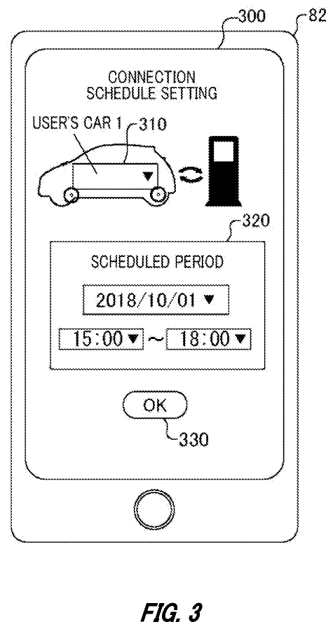

FIG. 3 illustrates one example of a screen 300 for setting a scheduled period over which a vehicle 30 is kept connected to a charge/discharge facility 20. The screen 300 is displayed on the user terminal 82 under the control of the managing server 40. The screen 300 includes a vehicle-30 selection menu 310, a scheduled period input menu 320, and an OK button 330.

The selection menu 310 is a menu for selecting a vehicle 30 to be a target to be connected to the charge/discharge facility 20. The input menu 320 is a menu for setting a scheduled connection date, the start time of scheduled connection time on the scheduled connection date, and the end time of the scheduled time. The scheduled period is determined by the scheduled connection date, start time, and end time. Note that, other than that a particular date itself is set, it may be possible to set one or more dates as scheduled connection dates by using information such as “weekdays”, “Saturday and Sunday”, “Saturday and holidays”, or “October”. It may be possible to set the start time, and end time of the scheduled connection time in any units such as 30-minutes time segments or one-hour time segments.

If the user 80 presses the OK button 330, the user terminal 82 sends, to the managing server 40, identification information of the user 80, identification information of the vehicle 30, and information indicating the scheduled period. At the managing server 40, the managing server 40 stores, in the schedule information storage unit 282, the information indicating the vehicle 30, and scheduled period sent from the user terminal 82, in association with the identification information of the user 80.

Note that the user 80 may access the managing server 40 by using the user terminal 82, and set the scheduled period him/herself. In addition, based on power demand acquired by the demand information acquiring unit 290 or a movement history of the user 80 or vehicle 30, the managing server 40 may decide a scheduled period to be presented to the user 80, send information indicating the decided scheduled period to the user terminal 82 by push notification, and cause the user 80 to select whether to or not to accept the presented scheduled period to thereby acquire a scheduled period.

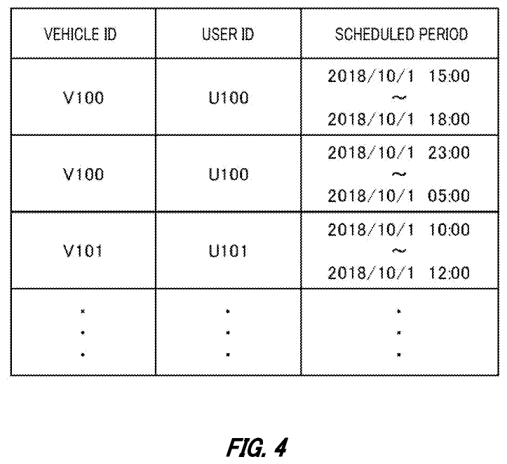

FIG. 4 illustrates, in a table format, one example of schedule information. The schedule information is stored in the schedule information storage unit 282 at the storage unit 48. The schedule information associates a vehicle ID, a user ID, and information indicating the scheduled period with each other.

As the vehicle ID, identification information of the vehicle 30 is stored. As the vehicle ID, identification information of the vehicle 30 set by the user 80 through the screen 300 illustrated in FIG. 3 or the like may be stored. As the user ID, identification information of the user 80 is stored. As the scheduled period, information indicating a scheduled period over which the vehicle 30 of the user 80 is kept connected to the charge/discharge facility 20 is stored. As the scheduled period, information indicating a scheduled period set by the user 80 through the screen 300 illustrated in FIG. 3 or the like may be stored.

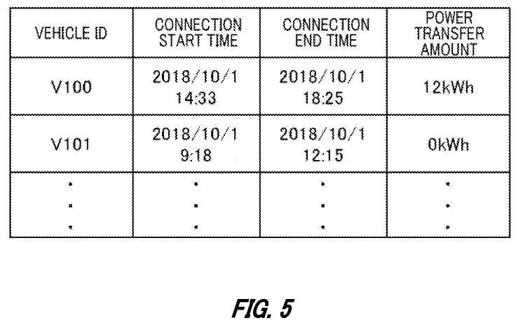

FIG. 5 illustrates, in a table format, one example of connection history information indicating a history of connection of the vehicle 30 to a power network 10. The connection history information is stored in the history storage unit 286. The connection history information associates a vehicle ID, a connection start time, a connection end time, and a power transfer amount with each other.

As the vehicle ID, identification information of the vehicle 30 is stored. As the connection start time, information indicating a time at which the vehicle 30 became available for power transfer with the power network 10 is stored. The connection start time may be identified based on power transferability information sent periodically from the charge/discharge ECU of the vehicle 30 to the managing server 40. As the connection start time, a time at which it became possible for the power transfer control unit 280 to control charge/discharge of the battery 32 after the charge/discharge cable 22 is attached to the vehicle 30, and charge/discharge facility 20 may be stored.

As the connection end time, information indicating a time at which it became impossible to perform power transfer between the vehicle 30 and the power network 10 is stored. The connection end time may be identified based on power transferability information sent periodically from the charge/discharge ECU of the vehicle 30 to the managing server 40. As the connection end time, information indicating an end time of a period over which the vehicle 30 was kept connected to the charge/discharge facility 20 through the charge/discharge cable 22 may be stored. As the connection end time, information indicating a time at which a power cable was disconnected from at least one of the vehicle 30 and the charge/discharge facility 20 may be stored. As the connection end time, information indicating a time at which it became impossible for the power transfer control unit 280 to control charge/discharge of the battery 32 may be stored.

As the power transfer amount, information indicating a net amount of power transferred between the vehicle 30 and the power network 10 from the connection start time to the connection end time is stored. Based on a power transfer amount of each of vehicles 30, the consideration control unit 270 generates information about an amount of money to be paid to a user 80 of each of the vehicles 30, and stores the information in the storage unit 48. The amount of money to be paid to the user 80 is calculated according to the power transfer amount. If the net power amount of power transferred from the vehicle 30 to the power network 10 is positive, the consideration control unit 270 calculates the amount of money to be paid to the user 80 based on the power transfer amount and a buying unit price. If the net power amount is negative, the consideration control unit 270 calculates the amount of money to be billed to the user 80 based on the power transfer amount and a selling unit price. The buying unit price is a price per unit power amount at which the power aggregator buys power from the user 80. The selling unit price is a price per unit power amount at which the power aggregator sells power to the user 80.

The consideration control unit 270 refers to the connection history information, and, if a scheduled period stored in the schedule information storage unit 282 is included in the period from the connection start time to connection end time, gives the user 80 a consideration. For example, for each of 30-minutes time segments included in the scheduled period, the consideration control unit 270 determines whether or not the entire period of each time segment is included in the period from the connection start time to the connection end time. For each time segment included in the period from the connection start time to the connection end time, the consideration control unit 270 gives a user 80 predetermined points. Note that, in the present embodiment, points are given for each time segment of power transaction. As the unit time based on which points are given, any unit of time other than time segments can be applied.

Note that the connection history information may be stored in any format as long as it is information that allows identification of whether or not the vehicle 30 was available for power transfer with the power network 10 irrespective of whether or not the vehicle 30 actually performed power transfer with the power network 10.

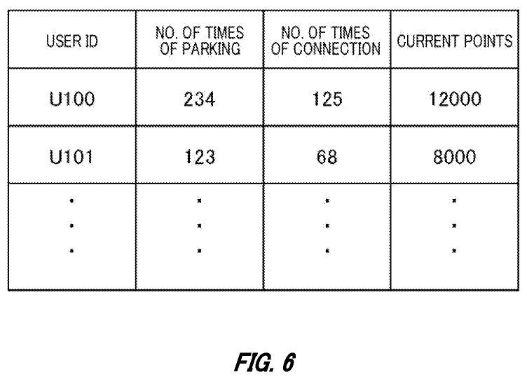

FIG. 6 illustrates, in a table format, one example of user information stored in the user information storage unit 284. The user information associates a user ID, a number of times of parking, a number of times of connection, and current points.

As the user ID, identification information of the user 80 is stored. As the current points, information indicating the current points having been provided to the user 80 is stored. The consideration control unit 270 refers to the connection history information, and schedule information, and, for each time segment included in a scheduled period associated with the user 80, adds points associated with the user 80 if the vehicle 30 was connected to the charge/discharge facility 20 in each time segment.

As the number of times of parking, information indicating the number of times the vehicle 30 has been parked at a location where the vehicle 30 can be connected to the charge/discharge facility 20 is stored. If the vehicle 30 received beacon information in a short distance wireless signal dispatched from the charge/discharge facility 20 during a period that starts when the vehicle 30 is parked and ends a predetermined length of time after, the vehicle 30 notifies a beacon reception notification to the managing server 40. If the managing server 40 received the beacon reception notification from the vehicle 30, the managing server 40 increases the value stored as the number of times of parking.

As the number of times of connection, information indicating the number of times the vehicle 30 has been connected to the charge/discharge facility 20 is stored. If the vehicle 30 is connected to the charge/discharge facility 20 through the charge/discharge cable 22, the vehicle 30 sends a connection notification to the managing server 40. If the managing server 40 received the connection notification from the vehicle 30, the managing server 40 increases the value stored as the number of times of connection.

In the power transfer system 100, the user 80 can use the points provided to the user 80 for charging the vehicle 30 with the stationary battery 14 at the time of emergency or at the time of disaster. For example, if the remaining capacity of the battery 32 of the vehicle 30 of the user 80 is lower than a predetermined value, the processing unit 42 of the managing server 40 permits charge of the battery 32 with the stationary battery 14, in exchange for subtraction of predetermined points from the current points having been provided to the user 80. In addition, the monthly usage fee of the charge/discharge facility 20 to be billed to the user 80 may be reduced according to the points provided to the user 80.

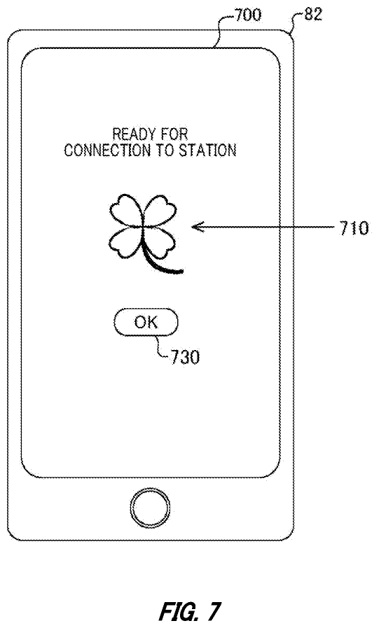

FIG. 7 illustrates one example of a screen 700 for notifying the user 80 that the vehicle 30 can be connected to the power network 10. The screen 700 is displayed on the user terminal 82 based on the control of the managing server 40. The screen 700 includes a notification object 710, and an OK button 730.

If the door of the driver's seat of the vehicle 30 is opened, the user terminal 82 displays the screen 700. For example, the ECU of the vehicle 30 notifies the managing server 40 of information indicating that the door of the driver's seat of the vehicle 30 is opened. If the managing server 40 receives the information indicating that the door of the driver's seat of the vehicle 30 is opened based on the information from the ECU of the vehicle 30, the notification control unit 220 causes a display instruction instructing to display the screen 700 to be sent to the user terminal 82 through the communicating unit 46. If the user terminal 82 received the display instruction from the managing server 40, the user terminal 82 displays the screen 700.

The notification object 710 on the screen 700 is one example of a mark representing that the vehicle 30 can be connected to the power network 10. Note that notification objects that can be employed include any objects other than the notification object 710 illustrated in FIG. 7. For example, symbols such as “O”, smiley faces, and the like may be employed as notification objects.

If the user 80 pressed the OK button 730 or if a predetermined length of time elapsed after the screen 700 is displayed, the user terminal 82 ends display of the screen 700. Thereby, the user 80 can be notified in a timely manner at a timing at which the user 80 connects the charge/discharge cable 22.

Note that the screen 700 is one example of methods to notify the user 80 that the vehicle 30 can be connected to the power network 10. Other notification methods that may be employed include a method in which a mark is displayed on an instrument panel of the vehicle 30, a method in which a mark is displayed on a navigation device of the vehicle 30, and other methods.

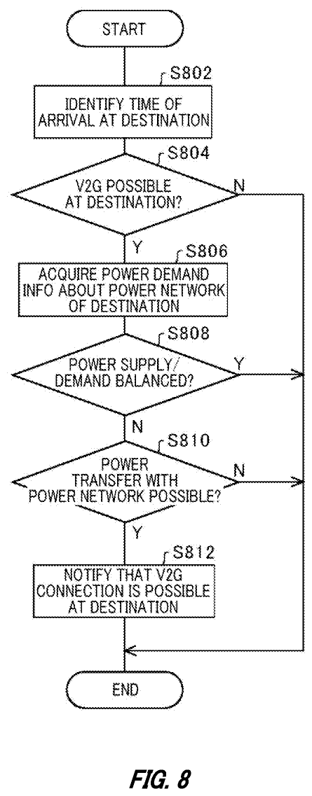

FIG. 8 is a flowchart illustrating processes related to user notification at the time of destination setting. The processes in the flowchart of FIG. 8 are executed mainly at the processing unit 42 of the managing server 40. The processes in the flowchart of FIG. 8 are started if, for example, the managing server 40 received a notification indicating that a destination is set on the navigation device of the vehicle 30.

At S802, the determining unit 240 identifies a time of arrival at the destination. For example, information indicating the time of arrival at the destination may be identified by the navigation device of the vehicle 30, and sent to the managing server 40. The determining unit 240 may acquire information indicating the time of arrival sent from the navigation device of the vehicle 30.

At S804, the notification control unit 220 determines whether or not V2G is possible at the destination. For example, if the destination is the commercial facility 150, and a charge/discharge facility 20 is provided at a parking lot of the commercial facility 150, the notification control unit 220 determines that V2G is possible at the destination. If V2G is not possible at the destination, the processes in this flowchart are ended.

If V2G is possible at the destination, at S806, the demand information acquiring unit 290 acquires information indicating power demand of the power network 10 at the destination. At S808, the notification control unit 220 determines whether or not power supply and demand of the power network 10 at the destination is balanced, based on the information acquired at S806. For example, if the absolute value of the difference between the power supply amount in the power network 10 at the destination and the power demand amount in the power network 10 is larger than a predetermined value, the notification control unit 220 determines that the power supply and demand of the power network 10 at the destination are not balanced. If the power supply and demand of the power network 10 at the destination are balanced, the processes in this flowchart are ended.

If the power supply and demand of the power network 10 at the destination are not balanced, at S810, the notification control unit 220 calculates the remaining capacity of the battery 32 that will be available when the vehicle 30 arrived at the destination, and determines whether or not power transfer can be performed between the battery 32 and the power network 10 based on the remaining capacity of the battery 32, and the power supply/demand balance in the power network 10. For example, if there is a shortage of power in the power network 10, the notification control unit 220 determines that power transfer can be performed between the battery 32 and the power network 10 when the remaining capacity of the battery 32 is larger than a predetermined value. On the other hand, if there is an excess of power in the power network 10, the notification control unit 220 determines that power transfer can be performed between the battery 32 and the power network 10 when the remaining capacity of the battery 32 is smaller than a predetermined value.

At S812, the notification control unit 220 causes information indicating that the vehicle 30 can be connected to the power network 10 at the destination to be sent to the user terminal 82 through the communicating unit 46. Thereby, the user 80 is notified that the vehicle 30 is available for power transfer with the power network 10 at the destination.

With the control by the managing server 40, it is possible to cause the user 80 to recognize that V2G can be performed at the destination if the user 80 set the destination. Thereby, it is possible to help the user 80 not forget to connect the vehicle 30 to the charge/discharge facility 20 at the destination.

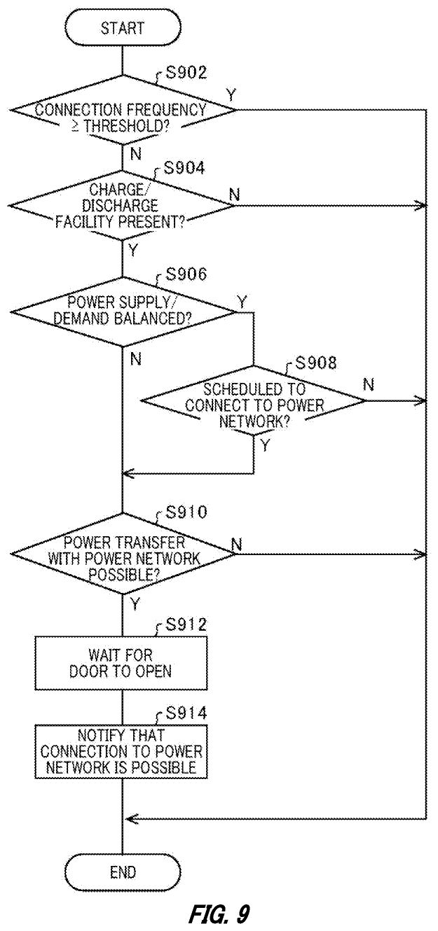

FIG. 9 is a flowchart illustrating processes related to user notification at the time of vehicle parking. The processes in the flowchart of FIG. 9 are executed mainly at the processing unit 42 of the managing server 40. The processes in the flowchart of FIG. 9 are started if, for example, the managing server 40 received from the vehicle 30 information indicating that the vehicle 30 is stopped.

At S902, the notification control unit 220 determines whether or not the frequency of connection of the vehicle 30 to the charge/discharge facility 20 at the time of parking of the vehicle 30 is equal to or higher than a threshold. The notification control unit 220 calculates the frequency of connection of the vehicle 30 to the charge/discharge facility 20 at the time of parking of the vehicle 30 by dividing the number of times of connection included in the user information illustrated in FIG. 6 with the number of times of parking. If the frequency of connection of the vehicle 30 to the charge/discharge facility 20 at the time of parking of the vehicle 30 is equal to or higher than the threshold, the processes in this flowchart are ended.

If the frequency of connection of the vehicle 30 to the charge/discharge facility 20 at the time of parking of the vehicle 30 is lower than the threshold, at S904, the determining unit 240 determines whether or not there is a charge/discharge facility 20 that can be connected to the power network 10. For example, the determining unit 240 determines whether or not a beacon reception notification has been received from the vehicle 30. If there is not a charge/discharge facility 20 that can be connected to the power network 10, the processes in this flowchart are ended.

If there is a charge/discharge facility 20 that can be connected to the power network 10, at S906, it is determined whether or not the power supply and demand in the power network 10 at the current position of the vehicle 30 are balanced. For example, based on power demand information acquired by the demand information acquiring unit 290, the notification control unit 220 determines whether or not the absolute value of the difference between the power supply amount and power demand amount in the power network 10 becomes larger than a predetermined value in a predetermined period from the current time.

If the power supply and demand are not balanced, at S910, the notification control unit 220 determines whether or not power transfer can be performed between the battery 32 and the power network 10 based on the remaining capacity of the battery 32 of the vehicle 30, and the power supply/demand balance in the power network 10. For example, if it is predicted that a shortage of power is to occur in the power network 10 in a predetermined period from the current time, the notification control unit 220 determines that power transfer can be performed between the battery 32 and the power network 10 when the remaining capacity of the battery 32 is larger than a predetermined value. On the other hand, if it is predicted that an excess of power is to occur in the power network 10 in a predetermined period from the current time, the notification control unit 220 determines that power transfer can be performed between the battery 32 and the power network 10 when the remaining capacity of the battery 32 is smaller than a predetermined value. If power transfer cannot be performed between the battery 32 and the power network 10, the processes in this flowchart are ended.

If power transfer can be performed between the battery 32 and the power network 10, at S912, the notification control unit 220 waits the door of the driver's seat of the vehicle 30 to open. When the door of the driver's seat of the vehicle 30 is opened, at S914, the notification control unit 220 causes the user terminal 82 to notify that the vehicle 30 can be connected to the power network 10. For example, the notification control unit 220 sends, to the user terminal 82, an instruction instructing to cause the screen 700 of FIG. 7 to be displayed on the user terminal 82.

Note that if it is determined in the determination at S906 that the power supply and demand are balanced, at S908, the notification control unit 220 determines whether or not connection of the vehicle 30 to the power network 10 has been scheduled. For example, the notification control unit 220 refers to the schedule information illustrated in FIG. 4 to determine whether or not connection of the vehicle 30 to the power network 10 has been scheduled. If connection of the vehicle 30 to the power network 10 has been scheduled, the process proceeds to S910. If connection of the vehicle 30 to the power network 10 has not been scheduled, the processes in this flowchart are ended.

As explained with reference to FIGS. 8, and 9, with the managing server 40, it is possible to notify the user 80 only if there is a possibility that power transfer will occur between the vehicle 30 and the power network 10. Because of this, there can be no wasteful notifications to the user 80. In addition, as explained with reference to FIG. 9, if the frequency of connection, by the user 80, of the vehicle 30 to the charge/discharge facility 20 is high, it is possible to inhibit notifications to the user 80. Because of this, for example, until the user 80 is well accustomed to connecting the vehicle 30 to the charge/discharge facility 20, notifications to the user 80 are performed in a timely manner, and after the user 80 is well accustomed to connecting the vehicle 30 to the charge/discharge facility 20, notifications to the user 80 can be inhibited.

As explained above, with the power transfer system 100, it is possible to notify the user 80 in a timely manner if it is desirable to connect the vehicle 30 to the power network 10. Thereby, it is possible to prevent the user 80 from forgetting to connect the vehicle 30 to the charge/discharge facility 20.

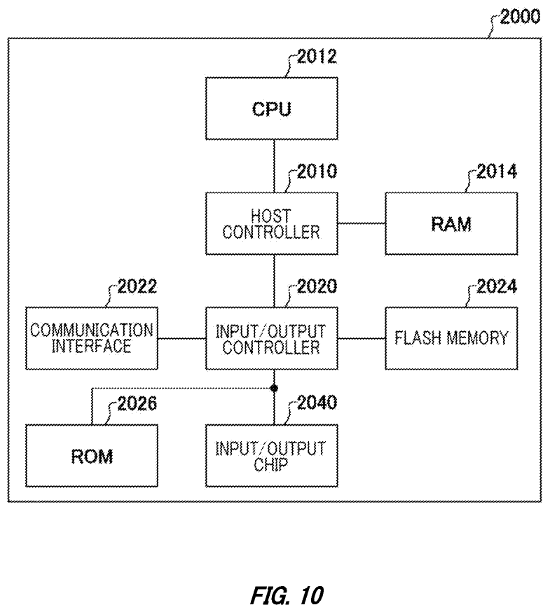

FIG. 10 shows an example of a computer 2000 in which embodiments of the present invention may be wholly or partly embodied. A program that is installed in the computer 2000 can cause the computer 2000 to function as or perform operations associated with apparatuses such as the managing server 40 of the embodiments or sections thereof, and/or cause the computer 2000 to perform processes of the embodiments of the present invention or steps thereof. Such a program may be executed by the CPU 2012 to cause the computer 2000 to perform certain operations associated with some or all of the blocks of flowcharts and block diagrams described herein.

The computer 2000 according to the present embodiment includes a CPU 2012, and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via the input/output controller 2020.

The CPU 2012 operates according to programs stored in the ROM 2026 and the RAM 2014, thereby controlling each unit.

The communication interface 2022 communicates with other electronic devices via a network. The flash memory 2024 stores programs and data used by the CPU 2012 within the computer 2000. The ROM 2026 stores therein a boot program or the like executed by the computer 2000 at the time of activation, and/or a program depending on the hardware of the computer 2000. The input/output chip 2040 may also connect various input/output units such as a keyboard, a mouse and a monitor to the input/output controller 2020 via an input/output port such as a serial port, a parallel port, a keyboard port, a mouse port, a monitor port, a USB port, an HDMI (registered trademark) port and the like.

A program is provided via a computer-readable medium such as a CD-ROM, a DVD-ROM, or a memory card or a network. The RAM 2014, the ROM 2026, or the flash memory 2024 is an example of the computer-readable medium. The program is installed in the flash memory 2024, the RAM 2014, or the ROM 2026, and is executed by the CPU 2012. The information processing described in these programs is read into the computer 2000, resulting in cooperation between a program and the above-mentioned various types of hardware resources. An apparatus or method may be constituted by realizing the operation or processing of information in accordance with the usage of the computer 2000.

For example, when communication is performed between the computer 2000 and an external device, the CPU 2012 may execute a communication program loaded onto the RAM 2014 to instruct communication processing to the communication interface 2022, based on the processing described in the communication program. The communication interface 2022, under control of the CPU 2012, reads transmission data stored on a transmission buffering region provided in a recording medium such as the RAM 2014, the hard disk drive 2024, the DVD-ROM 2001, or the IC card, and transmits the read transmission data to a network or writes reception data received from a network to a reception buffering region or the like provided on the recording medium.

In addition, the CPU 2012 may cause all or a necessary portion of a file or a database to be read into the RAM 2014, the file or the database having been stored in an external recording medium such as the flash memory 2024, and perform various types of processing on the data on the RAM 2014. The CPU 2012 may then write back the processed data to the external recording medium.

Various types of information, such as various types of programs, data, tables, and databases, may be stored in the recording medium to undergo information processing. The CPU 2012 may perform various types of processing on the data read from the RAM 2014, which includes various types of operations, processing of information, condition judging, conditional branch, unconditional branch, search/replace of information, etc., as described throughout this disclosure and designated by an instruction sequence of programs, and writes the result back to the RAM 2014. In addition, the CPU 2012 may search for information in a file, a database, etc., in the recording medium. For example, when a plurality of entries, each having an attribute value of a first attribute associated with an attribute value of a second attribute, are stored in the recording medium, the CPU 2012 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The program or software module explained above may be stored on the computer 2000 or a computer-readable medium located near the computer 2000. A recording medium like a hard disk or a RAM provided in a server system connected to a dedicated communication network or the Internet can be used as such a computer-readable medium. The program stored on the computer-readable medium may be provided to the computer 2000 via a network.

The programs that are installed on the computer 2000, and make the computer 2000 function as the managing server 40 may act on the CPU 2012 or the like to make the computer 2000 function as each unit of the managing server 40. Information processing described in these programs are read in by the computer 2000 to thereby make the computer 2000 function as the determining unit 240, notification control unit 220, power transfer control unit 280, demand information acquiring unit 290, schedule information storage unit 282, user information storage unit 284, and history storage unit 286, which are specific means attained by cooperation between software and various types of hardware resources mentioned above. With these specific means, the unique managing server 40 corresponding to a purpose of use of the computer 2000 in the present embodiment can be constructed by realizing operations on or processing of information corresponding to the purpose of use.

Various embodiments of the present invention may be described with reference to block diagrams and the like whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable media may include any tangible device that can store instructions for execution by a suitable device, such that the computer-readable medium having instructions stored therein comprises at least part of an article of manufacture including instructions which can be executed to create means for performing operations specified in the flowcharts or block diagrams. Examples of computer-readable media may include an electronic storage medium, a magnetic storage medium, an optical storage medium, an electromagnetic storage medium, a semiconductor storage medium, etc. More specific examples of computer-readable media may include a floppy disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer-readable instructions may be provided to a processor of a general purpose computer, special purpose computer, or other programmable data processing device, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

While the embodiments of the present invention have been described, the technical scope of the invention is not limited to the above described embodiments. It is apparent to persons skilled in the art that various alterations and improvements can be added to the above-described embodiments. In addition, matters explained about a particular embodiment can be applied to another embodiment as long as such application does not cause technological contradictions. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE SYMBOLS

10: power network
12: power generation facility
14: stationary battery
20: charge/discharge facility
22: charge/discharge cable
30: vehicle
32: battery
40: managing server
42: processing unit
46: communicating unit
48: storage unit
50: power transaction server
80: user
82: user terminal
100: power transfer system
150: commercial facility
240: determining unit
220: notification control unit
270: consideration control unit
280: control unit
282: schedule information storage unit
284: user information storage unit
286: history storage unit
290: demand information acquiring unit
300: screen
310: selection menu
320: input menu
330: OK button
700: screen
710: notification object
730: OK button
2000: computer
2010: host controller
2012: CPU
2014: RAM
2020: input/output controller
2022: communication interface
2024: flash memory
2026: ROM
2040: input/output chip

What is claimed is:

1. A control apparatus comprising:
a determining unit that determines whether or not a vehicle provided with a driving power source is at a position where the vehicle can perform power transfer with a power network; and
a notification control unit that makes a user of the vehicle notified, if the vehicle is at the position where the vehicle can perform power transfer with the power network.

2. The control apparatus according to claim 1, wherein, if the vehicle is positioned near a power transfer facility for performing power transfer between the vehicle and the power network, the determining unit determines that the vehicle is at the position where the vehicle can perform power transfer with the power network.

3. The control apparatus according to claim 1, wherein, if the vehicle receives a predetermined signal as a short distance wireless signal from a power transfer facility for performing power transfer between the vehicle and the power network, the determining unit determines that the vehicle is at the position where the vehicle can perform power transfer with the power network.

4. The control apparatus according to claim 1, wherein, if the vehicle is at the position where the vehicle can perform power transfer with the power network, the notification control unit makes a user of the vehicle notified, when the vehicle is stopped.

5. The control apparatus according to claim 1, wherein, if the vehicle is at the position where the vehicle can perform power transfer with the power network, the notification control unit makes a user of the vehicle notified, when a door of the vehicle is opened.

6. The control apparatus according to claim 1, wherein, based on power demand in the power network with which the vehicle can perform power transfer, the notification control unit determines whether to or not to make a user of the vehicle notified.

7. The control apparatus according to claim 1, wherein, based on power demand in the power network with which the vehicle can perform power transfer, the notification control unit determines whether or not there is a possibility that power transfer will be performed between the power network and the vehicle, and makes a user of the vehicle notified, if there is a possibility that power transfer will be performed between the power network and the vehicle.

8. The control apparatus according to claim 1, wherein, based on a power capacity that is available in the driving power source for power transfer with the power network, the notification control unit determines whether or not the driving power source is available for power transfer with the power network, and makes a user of the vehicle notified, if the driving power source is available for power transfer with the power network.

9. The control apparatus according to claim 1, wherein
if a destination of the vehicle is set, the determining unit further determines whether or not power transfer can be performed at the destination between the vehicle and a power network that supplies power in a region including the destination, and
if power transfer can be performed at the destination between the vehicle and the power network that supplies power in the region including the destination, the notification control unit further makes a user of the vehicle notified.

10. The control apparatus according to claim 9, wherein, if it is determined that there is a possibility that power transfer will be performed between the power network and the vehicle based on power demand in the power network that supplies power in the region including the destination in a time segment in which the vehicle arrives at the destination, the notification control unit makes the user of the vehicle notified.

11. The control apparatus according to claim 9, wherein the notification control unit predicts a power capacity that is available in the driving power source for power transfer with the power network when the vehicle arrives at the destination, and, if power transfer can be performed between the driving power source and the power network based on the predicted power capacity, makes the user of the vehicle notified.

12. The control apparatus according to claim 1, wherein the driving power source is a battery.

13. A non-transitory computer-readable storage medium having stored there on a program for causing a computer to function as:
a determining unit that determines whether or not a vehicle provided with a driving power source is at a position where the vehicle can perform power transfer with a power network; and
a notification control unit that makes a user of the vehicle notified, if the vehicle is at the position where the vehicle is available for power transfer with the power network.
